(19) United States
(12) Patent Application Publication
(10) Pub. No.: US 2015/0199623 A1
(43) Pub. Date: Jul. 16, 2015

(54) METHOD FOR RESOURCE ALLOCATION IN MISSION PLANNING

(71) Applicants: Magnus Andersson, Linkoping (SE); Kristian Lundberg, Vreta Kloster (SE); Nils-Hassan Quttineh, Linkoping (SE)

(72) Inventors: Magnus Andersson, Linkoping (SE); Kristian Lundberg, Vreta Kloster (SE); Nils-Hassan Quttineh, Linkoping (SE)

(73) Assignee: SAAB AB, Linköping (SE)

(21) Appl. No.: 14/400,234

(22) PCT Filed: May 11, 2012
(86) PCT No.: PCT/SE2012/000070

§ 371 Date: Mar. 18, 2015

(51) Int. Cl. G06Q 10/06

(52) U.S. Cl. CPC G06Q 10/063

(57) ABSTRACT

A method for planning attacking targets to optimize a use of own available resources in a target area based upon information on own resources available for attacking and information on protected and non-protected targets located in the target area. Different attack tactics are collected in a first library. Different defense strategies are collected in a second library. A reward value is allotted to each target and threat in the target area. Each target and threat in the target area has a defense capability and a vulnerability. The different attack tactics for a chosen defense strategy are evaluated to find an optimal attack tactic having a highest possible accumulated value of target reward value combined with a defeat probability value. The found optimal attack tactic is utilized to create an attack plan involving information on resources needed, targets to attack and attacking directions and time delays.

### TECHNICAL FIELD

The present invention relates to a method for resource allocation in mission planning, planning attacks on targets to optimize the use of own available resources in a target area based upon information on own available resources and information of targets in the target area. The method is suitable for use against land based or sea based targets being stationary, semi stationary or moving.

### BACKGROUND

Attack planning per se is generally known and it can for example be referred to US 2006/0271245 A1, US 2007/0244673, US 2012/0000349 A1, and WO 2006/027319 A1, all cited documents discussing planning of attacks based upon information about available resources. Examples of systems primary intended for defensive purposes involving some kind of planning to meet attacking resources are known from U.S. Pat. No. 5,153,366 A and a publication by Orhan Karasakal, Nur Evin Ozdemirel and Levent Kandiller, Anti-Ship Missile Defence for a Naval Task Group, Naval Research Logistics, Vol. 58 (2011), pp 305-322.

### SUMMARY OF THE INVENTION

The main objective of the invention is to obtain a more effective use of available resources.

The objective is obtained by a method characterized in that different attack tactics are collected in an attack tactics first library and different defence strategies are collected in an defence strategy library second library, that each target in the target area are allotted a reward value, that different attack tactics for a chosen defend strategy are evaluated to find an optimal attack tactic having highest possible collected reward value, the found optimal attack tactic being used to create a reliable and effective attack plan involving information on inter alia resources needed, positions of targets to be attacked, attacking directions and time.

By collecting information as collections of tactics on the attacking side as well as presumptions of strategies from the defending side in libraries, allotting each target in the target area a reward value, and evaluate different attack tactics for a chosen defend strategy to find an optimal attack tactic having highest possible collected reward value, an optimal attack tactic is found used to create a reliable and effective attack plan.

It is here to be noted that the first and second libraries may be spatially separated but can also be included in a common more comprehensive library.

Advantageously the method is characterized in that the optimization of the total set of attacks, one attack per target, is based on:
a) choosing each attack in such a way that the total accumulated value of target reward value combined with the defeat probability value is maximized.
b) setting constraints regarding the interaction between each set of target attacks, one per target, and how the defence strategy reacts upon these attacks. Each attack direction and target position defines the total geometry of attack directions in the target area. The allocation of defence capability is specified according to the defence strategy which finally connects attacks and the defined defence strategy.
   Another constraint limits the available resources.
c) Parameters used above and in the constraints, describes attack capability, i.e. the defeat probability per attack and target type, the target defence capability model per target, target position, target velocity and target reward value as well as target protection value.

In order to carry out the optimization it is proposed as one alternative that mixed integer programming techniques, such as branch & bound, are used as optimization method.

According to another alternative it is proposed that heuristics, such as Tabu Search, Genetic Algorithms or Simulated Annealing are used as optimization method.

Preferably target and threat defence capability is modelled as areas in a 2-dimensional case and as volumes in a 3-dimensional case.

According to one favourable concept the target and threat defence capability is modelled with the shape of an ellipse, circle or a collection of circle segments with different ranges in the 2-dimensional case.

According to another favourable concept the target and threat defence capability is modelled with the shape of an ellipsoid, sphere or a collection of circle angular areas with different ranges in the 3-dimensional case.

The proposed 2-dimensional target areas and the proposed 3-dimensional target volumes are examples of areas and volumes that inter alia mathematically are suitable for the model concept. However, other 2-dimensional areas or 3-dimensional volumes can be used and are not excluded in connection with the invention,

According to a still another favourable concept a number of possible attack directions towards a target are pre-distributed around the target. In a particular variant the possible attack directions from start are modelled as evenly distributed. By an even distribution the calculation can be made easier. However this does not exclude a free choice of direction or that some of the evenly distributed directions are taken away in a wider aspect of the claimed invention.

It is here to be noted that the real flight path of a resource, for example a missile, to the target preferably undergoes consecutive or continuous manoeuvres of directions to follow a safer flight path.

According to another favourable concept an attack tactic involves setting a plurality of resources to attack a target in the same direction.

According to a favourable method of the invention a defence strategy collected in the second library involves prioritization of the target itself relative to surrounding targets and their protection values.

According to a further favourable method of the invention a defence strategy collected in the second library involves the following items:

a) primary defending the target itself
b) secondary defending other targets starting with the closest attack path first and followed by attack paths in a falling scale within the target's defence area.

Such a strategy primary protects the target itself and dedicates the remaining defence capabilities to near by attack paths in succession.

According to another favourable method of the invention a defence strategy collected in the second library involves the following items:

a) primary defending the target itself
b) secondary defending a target of highest value

In this case again the target itself is protected primary while secondary a target within the target area of particular importance is protected. In a naval scenario it could be a ship surrounded by other ships and essential for the total commanding and guidance of the fleet.

According to still another favourable method of the invention a defence strategy collected in the second library comprises a minor use of self defence and allotting most of the defence capabilities to defend high valuable targets. Such a strategy still more enhances the possibility to protect important and valuable targets.

Preferably, according to the method of the invention each target is allotted a reward value manually by an operator or automatically based upon knowledge of the target. By allotting such a reward value to each target an overview of the consequences of different tactics is easily calculated and evaluated as a base for the final attack plan to be carried out.

In particular it is proposed according to the method of the invention that different tactics are evaluated together with the number of resources towards each target by calculating effect probabilities by multiplying the probability for hit in a for the collected tactics with the target with the vulnerability value with the reward value and sum up for all targets.

Preferably, according to a favourable carrying out of the method, the method to find an optimal attack tactic is continuously repeated to compensate for changes within the target area.

Based upon a created attack plan, an allocation of own available resources are carried out that preferably can involve different platforms.

According to still another favourable method of the invention is that the optimizing to maximize target function and minimize resources to be used is based on

a) finding and mapping of targets in the target area,
b) setting constraints regarding defence tactics, distribution in different attack directions, number and capacity of available resources, such as missiles,
c) deciding set of tactics to be chosen towards each target and attack directions.

Further favourable method of the invention is that mixed integer programming techniques, such as branch and bound, are used for optimizing and/or that heuristics, such as Tabu Search or genetic algorithms, are used for optimizing and/or that the collected attack tactics model the behaviour and interaction between own available resources and/or that the collected defence tactics or strategy model the behaviour and interaction between the targets and the threats and/or that uncertainties of the target area information are modelled as an adjusted defence capability.

Concerning the collected attack tactics they model the behaviour and interaction between own available resources. Concerning the collected defence tactics they model the behaviour and interaction between the targets and the threats.

Concerning vulnerability it is proposed that vulnerability of the separate targets is modelled as a function of hit position, hit speed, attack direction and lethality of own resources.

It is also proposed in a capability defence model that the defence capability model includes the sum of the target's different hard kill and soft kill capabilities.

### BRIEF DESCRIPTION OF THE DRAWINGS

The invention will now be described in more detail with reference to the accompanying drawings in which:

FIG. 1 schematically illustrates the principals behind a method according to the invention.

FIG. 2a-2e illustrates examples of five different attack tactics that can be used towards a target.

FIG. 3a-3b illustrates two different examples of defence areas allotted a target.

FIG. 4 illustrates a fleet of ships and how different tactics can be applied.

FIG. 5a-5b shows a first example of a defence volume in the shape of a rotation paraboloid in top view, FIG. 5a and vertical cross section, FIG. 3b.

FIG. 6a-6b shows a second example of a defence volume in the shape of a semi sphere in top view, FIG. 6a, and vertical cross section, FIG. 6b.

FIG. 7a-7b shows a third example of a defence volume in top view, FIG. 7a and vertical cross section, FIG. 7b.

FIG. 8 schematically illustrates the two principle planning operations included in the method described with reference to FIG. 1.

### DETAILED DESCRIPTION

Targets are hostile objects within the target area, either being an object to be attacked or an object threatening our resources.

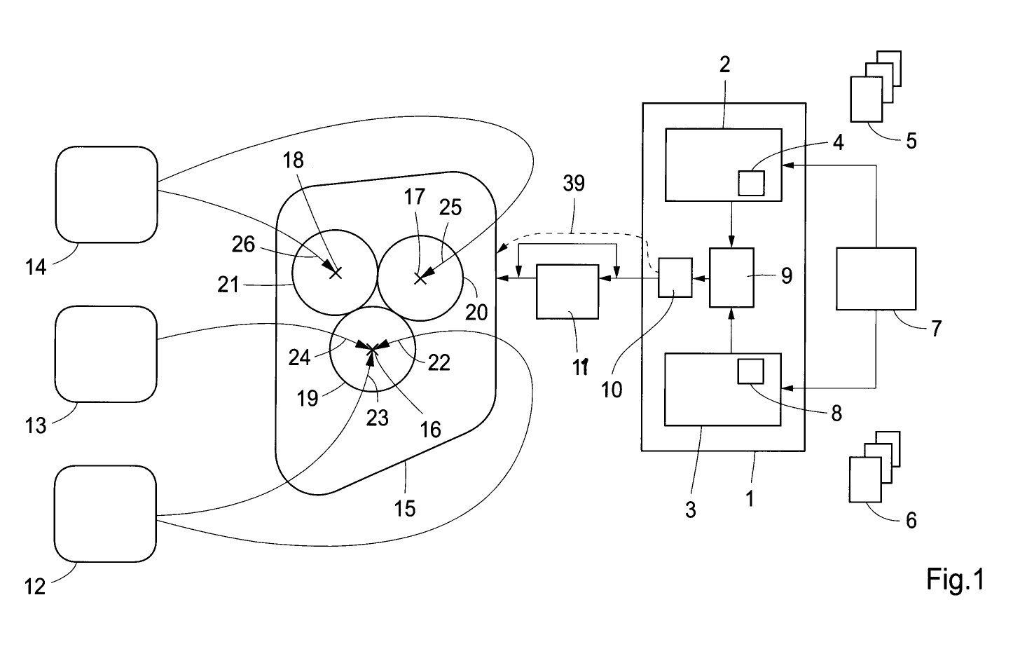

According to FIG. 1 there is an optimizing operation 1 comprising an attack section 2 and a defence section 3. Block 7 are provided with target area information, e.g. target positions, types of targets, movements, target defence capability, performance of own resources such as missiles and the total number of different available own resources. The attack section 2 and defence section 3 are provided with model information from block 7, e.g. parameter values of the target defence capability models. Furthermore information about manual or automatic rewarding of targets to be taken notice of can be available.

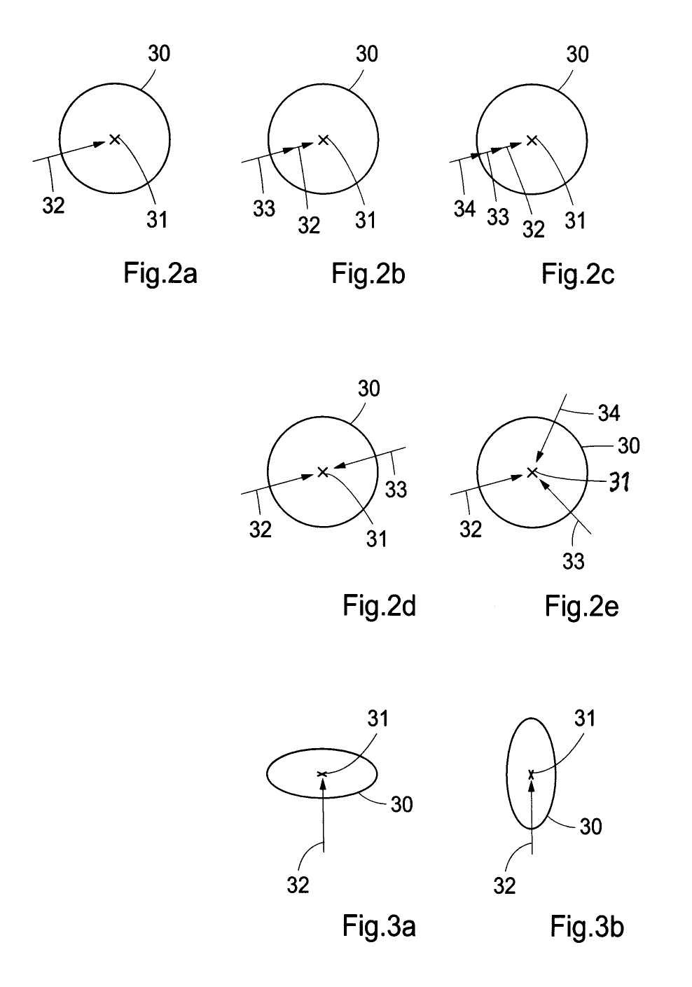

Based upon the information provided by the block 7 the attack section 2 has sufficient information about targets in a target area to be attacked to start up an optimizing operation. Further the attack section 2 now has information about its own resources such as available types of resources, number of different resources, performance of resources and similar information. This information can be stored in a block 4. Examples of weapon resources are missiles, rockets, bombs, artillery grenades etc. The attack section 2 comprises or is connected to a attack tactic library 5 for storing collections of attack tactics. Tactic models will be discussed in more detail below with reference to FIGS. 2-4. The library is continually open for new tactics.

In a corresponding way the defence section 3 receives information concerning targets from the collecting block 7 that can be stored in a block 8. The defence section 3 is connected to a defence strategy library 6 for storing a plurality of defence strategies or defence tactics. Examples of defence strategies for a naval application are e.g. that the targets primary uses their defence capabilities in self defence, that the targets uses their defence capabilities primarily to protect other (high-value) targets or a combination of both where a protection value defines the target's ranking. The remaining defence capability, after self-defence, can also be used to protect other targets in accordance with the defence strategy. One way of doing this is to protect other targets starting with the closest attacking resource first and then defeating the attacking resources in accordance with the defence strategy and as far as the defence capabilities are sufficient. Another possible strategy is that the targets assist other targets having the highest protection value. Yet another possibility is that all targets uses minimal self defence in favour of the defending of a highly ranked target.

Advantageously the method is characterized in that the optimization of the total set of attacks, one attack per target, is based on:
a) choosing each attack in such a way that the total accumulated value of target reward value combined with the defeat probability value is maximized.
b) setting constraints regarding the interaction between each set of target attacks, one per target, and how the defence strategy reacts upon these attacks. Each attack direction and target position defines the total geometry of attack directions in the target area. The allocation of defence capability is specified according to the defence strategy which finally connects attacks and the defined defence strategy.
   Another constraint limits the available resources.
c) Parameters used above and in the constraints, describes attack capability, i.e. the defeat probability per attack and target type, the target defence capability model per target, target position, target velocity and target reward value as well as target protection value.

In order to carry out the optimization it is proposed as one alternative that mixed integer programming techniques, such as branch&bound, are used as optimization method.

According to another alternative it is proposed that heuristics, such as Tabu Search, Genetic Algorithms or Simulated Annealing are used as optimization method.

The target's defence capabilities can consist of one or several guns, surface-to-air missiles and other countermeasure systems, e.g. electronic countermeasure systems, chaff systems, smoke, intense illumination, laser systems and so on.

In a calculating and controlling block 9 the different attack tactics are evaluated for a defence strategy based upon reward values allotted the different targets in the target area 15. The allotting of reward values is based upon information received from the collecting block 7. The evaluating results in that an optimal attack tactic is found having highest possible collected reward value of the targets planned to be defeated. This found optimal attack tactic is then used to create an attack plan involving information on inter alia resources needed, targets to be attacked, e.g. their positions, attack directions and time delays. This attack plan is calculated and provided by block 9

An optimal attack plan supplied directly by block 9 is now available comprising target choices with positions, attack directions and time delays. Starting from this attack plan different resources on the platforms are allocated to the targets. The allocation can be exercised by the calculating and computing block 9 having all information available. A dashed line 39 indicates the allocating control of available resources by the calculating and controlling block 9.

An exemplified solution with a proposed allocation of resources is shown in the left part of FIG. 1 comprising three platforms 12, 13, 14, a target area 15 with three targets 16, 17, 18 to be attacked. Each target being allotted a defence area 19, 20, 21. According to the solution, target 16 is to be attacked from three directions 22, 23, 24, two of the directions 22, 23 emanating from platform 12 and one direction 24 emanating from platform 13. Target 17 is to be attacked from one direction 25 emanating from platform 14. Target 18 is also to be attacked from one direction 26 emanating from platform 14. In this context the platforms can be of different kinds and the resources can be of different kinds. Air borne, ship borne and/or land based platforms with their resources can carry out the calculated attack plan. For example, the attacks can be based on missiles launched from aircrafts.

When looking at target 16 a time delay could be introduced to first attack the target 16 in direction 22 and thereafter attack target 16 simultaneously in directions 23 and 24.

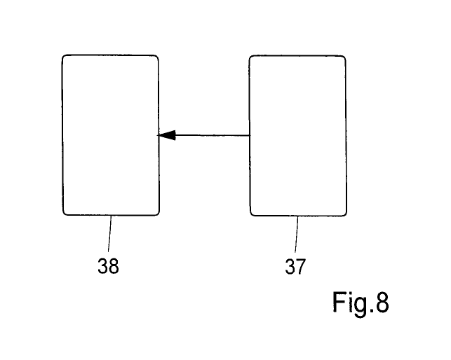

The principles described with reference to FIG. 1 above can be seen as two planning operations and schematically illustrated in FIG. 8. According to FIG. 8 there is an attack planning block 37 and a resource to platform allocation block 38. In the attack planning block 37 different attack tactics are evaluated that finally results in an attack plan. This attack plan is the basis for allocating different resources in the allocating block 38. From the allocating block 38 different platforms 12-14 to be involved are allocated.

The attack tactics library is a set of attack tactics. An attack tactic is a single possible behaviour for each of one the resources. For every target, separate attacks could be applied, where an attack consists of a configuration of relative attack directions geometry, see FIG. 2a-2e, a base attack direction parameter and a time delay. The purpose of the attack tactics library is to model the preferable behaviours of the resources, e.g. saturation effects on the targets defence systems, robustness against target heading when attacking from different directions etc.

A defence strategy describes a target's behaviour due to all hostile resources within its defence area. The purpose of the defence strategy library is to model the intelligent behaviours of the targets separate defence systems as well as the communication and interaction between the targets and their command and control systems when reacting on an attack.

The target vulnerability model describes the target's vulnerability w.r.t. e.g. different hit positions, attack directions, resource impact speed and lethality. The output of the target vulnerability model function is the effect on the target, e.g. probability or fraction being defeated.

The target defence model describes the target's capability of defeating the resource, including all the target's defence systems, e.g. all its hard kill and soft kill countermeasure capabilities. The survivability is here the capability, e.g. defined as the probability, for own resource not being defeated.

According to another favourable concept the target defence model is defined as intensity per area unit in the 2-dimensional case and per volume unit in the 3-dimensional case, where the defence area/volume defines the inner and outer range bounds of the target's defence systems.

According to another favourable concept the survivability probability for own resource not being defeated is being computed as the integral of the target defence model function w.r.t. flight time through the defence area/volume.

In particular it is proposed according to the method of the invention that different tactics are evaluated together with the number of resources towards each target by calculating effect probabilities by multiplying the probability for hit in a for the collected tactics with the target with the vulnerability value with the reward value and sum up for all targets.

Based upon a created attack plan, an allocation of own available resources are preferably carried out that preferably can involve different platforms.

In FIG. 2a-2e five different tactics towards a single target are illustrated. According to the model concept shown, a circular defence area 30 is allotted a target 31. According to the tactic shown in FIG. 2a one single resource 32 is allotted the target. According to the tactic shown in FIG. 2b two resources 32, 33 are allotted the target 31 and both resources are attacking in the same direction. According to the tactic shown in FIG. 2c three different resources 32, 33, 34 are attacking in the same direction. According to the tactic shown in FIG. 2d two different resources 32, 33 are attacking the target. In this case the resources are attacking from different directions and in the figure more exactly in two opposite directions. Finally, according to the tactic shown in FIG. 2e there are three different resources 32, 33, 34 attacking the target 31. In the example in FIG. 2e, the attacking directions are evenly distributed around the target separated 120 degrees from each other.

In the preceding paragraph five different tactics have been explicitly shown. It is however easily realized that quite a plurality of different tactic models are possible. The tactics also include a time delay between the resources attacking the targets in the target area. The different tactic models are shown in two direction applications. It is also possible to use tactic models in three dimensions. One particular tactic to consider is not to attack a target.

Preferably, according to a favourable carrying out of the method, the method to find an optimal attack tactic is continuously repeated to compensate for changes within the target area.

The circular defence area shown is just one possibility. The defence areas 30 can assume quite different shapes and two examples with elliptical shape are shown in FIGS. 3a and 3b, respectively, for a target 31 subjected to one resource 32.

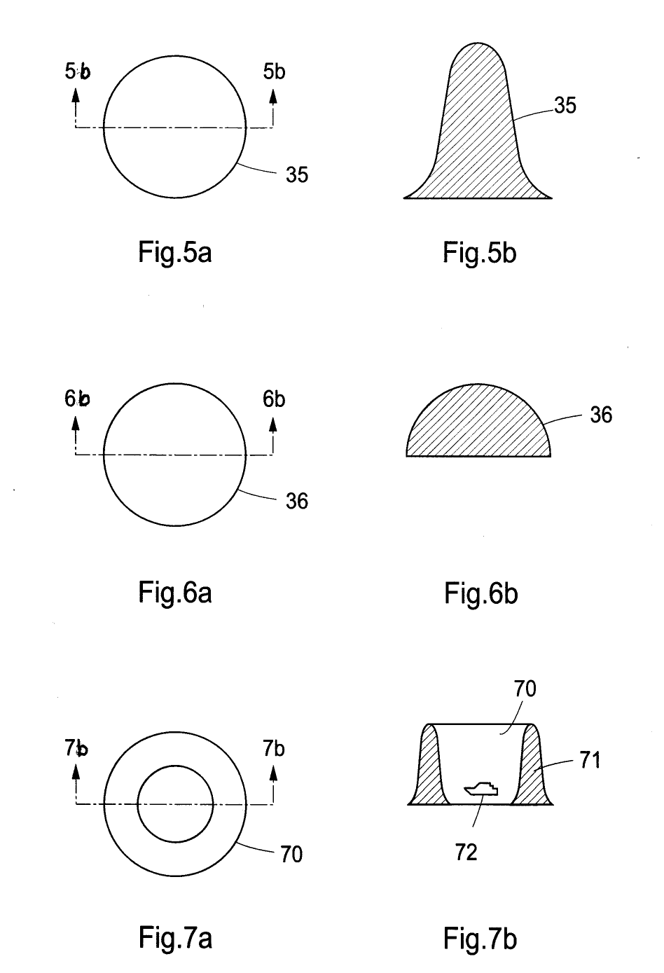

Three examples of three dimensional defence models are shown in FIG. 5a-5b, FIG. 6a-6b, and FIG. 7a-7b, respectively. According to FIGS. 5a and 5b a rotation paraboloid 35 is shown in top view, FIG. 5a, and vertical cross section, FIG. 5b. A dash dotted line in FIG. 5a indicates the view of FIG. 5b. According to FIGS. 6a and 6b a semi sphere 36 is shown in top view, FIG. 6a, and vertical cross section, FIG. 6b. A dash dotted line in FIG. 6a indicates the view of FIG. 6a. According to FIG. 7a-7b the volume 70 is shaped rotationally symmetric with a Gaussian clock-like vertical cross section. A dash dotted line in FIG. 7a indicates the view of FIG. 7b. The above defence capability models here are only to be seen as examples not excluding any other possible three dimensional models.

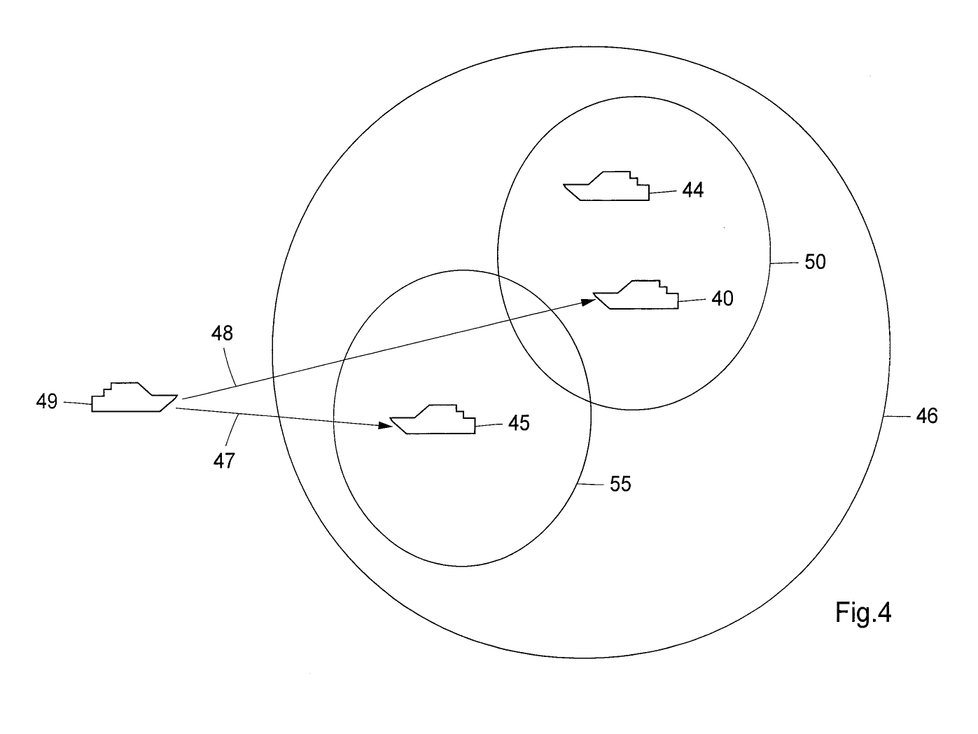

Referring now to FIG. 4, where an example of a naval application is discussed. The figure shows three ships 40, 44 and 45 in a target area 46. In the scenario there is also shown a ship 49 with two resources 47, 48 attacking targets within the target area 46. The ship 40 is highly valuable and important to protect. A defence area 50 and 55 is allotted each ship 40 and 45 respectively. Ship 44 has no defence capability of its own and is totally dependent on protection from other ships. When missiles 47 and 48 simultaneously attacks the target area, the ship 45 primary defends itself against missile 47 and secondary defends the highly valuable ship 40 against missile 48. If resources remain it can also defend other ships if other missiles occur.

It is now reverted to FIG. 1 to further describe the method applied for a patent. As already stated that attacks tactics and defence strategies are collected in libraries 5, 6. When the attack is being planned each object/ship is allotted a value. This value may be decided by an operator or automatically supplied. The aim of the planning is to maximize a collected shoot down value. This is carried out by evaluating different attack tactics together with the number of missiles towards each target. The probability for hit in a target for the collected tactic and the effect in the target is combined with a target value and is summed up for all targets. In this context it is not necessary to shoot down all ships due to the fact that the resources may be more usable in other tactics towards other targets. The maximum number of resources is not allowed to be exceeded in a complete attack. During this evaluation the effect of chosen tactics is evaluated for one assumed defence tactic. An attack plan is determined based upon the evaluation and thereafter resources are allocated. When evaluating attack tactics one particular tactic to consider is not to use a resource or missile. The process above involves two steps as illustrated by planning and allocating blocks 37, 38 in FIG. 8. In a first step a planning of attacks takes place.

The attack planning in the first step then supplies information to be processed in a second step allocating resources such as missiles to the platforms.

The optimization process could be performed for different number of the available resources, enabling a process where the minimum number of resources is achieved for a specified mission success.

The method of the invention is not limited to the examples described above but may be modified within the scope of the attached claims.

1-24. (canceled)

25. A method for planning attacking targets to optimize a use of own available resources in a target area based upon information on own resources available for attacking and information on protected and non-protected targets located in the target area, the method comprising:
collecting different attack tactics in a first library;
collecting different defense strategies in a second library;
allotting a reward value to each target and threat in the target area, wherein each target and threat in the target area has a defense capability and a vulnerability;
evaluating the different attack tactics for a chosen defense strategy to find an optimal attack tactic having a highest possible accumulated value of target reward value combined with a defeat probability value; and
utilizing the found optimal attack tactic to create an attack plan involving information on resources needed, targets to attack and attacking directions and time delays.

26. The method according to claim 25, further comprising:
modelling the targets and threat defense capability as areas in a 2-dimensional case and as volumes in a 3-dimensional case.

27. The method according to claim 25, further comprising:
modelling the targets and the threat defense capability as areas in a 2-dimensional case with the shape of an ellipse, circle or a collection of circle segments with different ranges.

28. The method according to claim 25, further comprising:
modelling the targets and threat defence capability are modelled as areas in a 3-dimensional case with the shape of an ellipsoid, sphere or a collection of circle angular areas with different ranges.

29. The method according to claim 25, further comprising:
pre-distributing around the target a plurality of possible attack directions towards a target.

30. The method according to claim 25, further comprising:
modelling as evenly distributed the possible attack directions from start.

31. The method according to claim 25, wherein said attack tactic comprising setting a plurality of resources to attack a target in a same direction.

32. The method according to claim 25, wherein a defense strategy collected in the second library comprises prioritization of the target itself relative to surrounding targets and protection values of the surrounding targets.

33. The method according to claim 25, wherein defense strategies collected in the second library comprise:
primary defending the target itself, and
secondary defending other targets starting with the closest attack path first and followed by attack paths in a falling scale within the defense area of the target.

34. The method according to claim 25, wherein said defense strategies collected in the second library comprises:
primary defending the target itself, and
secondary defending a target of highest value.

35. The method according to claim 25, wherein defense strategies collected in the second library comprise a minor use of self-defense and allotting most of defense ability to defend high valuable targets.

36. The method according to claim 25, further comprising:
manually rewarding each target a reward value by an operator or automatically based upon knowledge of the target.

37. The method according to claim 25, wherein different tactics are evaluated together with the number of resources towards each target by calculating effect probabilities by multiplying a probability for hit in a target for the collected tactics with the reward value of the target and sum up for all targets.

38. The method according to claim 25, wherein the finding of an optimal attack tactic is continuously repeated to compensate for changes within the target area.

39. The method according to claim 25, further comprising:
carrying out an allocation of own available resources based upon the attack plan created.

40. The method according to claim 25, wherein the optimizing to maximize target function and minimize resources to be used is based on
finding and mapping of targets in said target area,
setting constraints regarding defense tactics, distribution in different attack directions, number and capacity of available resources, and
deciding set of tactics to be chosen towards each target and attack directions.

41. The method according to claim 25, wherein mixed integer programming techniques are used for optimizing.

42. The method according to claim 25, wherein heuristics are used for optimizing.

43. The method according to claim 25, wherein the collected attack tactics model the behavior and interaction between own available resources.

44. The method according to claim 25, wherein the optimization of the total set of attacks, one attack per target, is based on:
selecting each attack so that the total accumulated value of said target reward value combined with said defeat probability value is maximized,
setting constraints regarding the interaction between each set of target attacks, one per target, and how the defense strategy reacts upon these attacks,
allocating defense capability according to defense strategy, and
defining attack capability based upon the selected attacks, defined constraints and the allocated defense capability.
